(19) United States
(12) Patent Application Publication
(10) Pub. No.: US 2013/0186698 A1
(43) Pub. Date: Jul. 25, 2013

(54) STAIR CLIMBING WHEELED VEHICLE, AND SYSTEM AND METHOD OF MAKING AND USING SAME

(71) Applicants: Joseph Sarokhan, Basking Ridge, NJ (US); Steven Kamara, Princeton, NJ (US); Michael Yang, Princeton, NJ (US)

(72) Inventors: Joseph Sarokhan, Basking Ridge, NJ (US); Steven Kamara, Princeton, NJ (US); Michael Yang, Princeton, NJ (US)

(21) Appl. No.: 13/668,186

(22) Filed: Nov. 2, 2012

Related U.S. Application Data
(60) Provisional application No. 61/554,691, filed on Nov. 2, 2011.

(51) Int. Cl. B62B 5/02

(52) U.S. Cl. CPC B62B 5/026
USPC 180/7.1

(57) ABSTRACT

A wheeled vehicle comprising a power-driven spider assembly for ascending and descending stairs. The vehicle includes an angular position sensor providing input to a controller operable to control a servo-motor to effectively lock the position of the spider relative to the frame, regardless of the hand truck's spatial orientation relative to a vertical plane, or any balancing of the hand truck. The angular position sensor provides input to the controller, which is programmed with predefined angular zones of instability, and causes the controller to accelerate rotation of the spiders through those zones when the wheeled vehicle is in the descent mode, to avoid instability of the hand truck. A hand truck may include a removable basket and/or a pivotable platform usable to transport loads.

### CROSS-REFERENCE TO RELATED APPLICATIONS

This application is a continuation of U.S. Patent Application Serial No. N/A, filed Nov. 2, 2011, initially U.S. Provisional Application No. 61/554,691, the entire disclosure of which is hereby incorporated herein by reference.

### FIELD OF THE INVENTION

The present invention relates generally to stair-climbing wheeled vehicles, and more particularly to an electrically powered or power-assisted, spider-, cluster-, or wheel-over-wheeled stair-climbing vehicle, such as a hand truck, having microprocessor-controlled modes for facilitating the balancing and maneuvering of the vehicle.

### BACKGROUND

Hand trucks, wheelchairs, and other wheeled vehicles (collectively, “vehicles”) are well known, but electrically-powered vehicles having the ability to climb stairs are a relatively recent innovation. Such vehicles are typically complex, expensive, and difficult to use.

There have been numerous attempts to create a stair-climbing vehicle based on a spider, or wheel-over-wheel, design. While tri-wheel spider assemblies are well-suited for stair climbing, they generally have substantial steering problems when used on flat ground. Since a pair of tri-wheel spider assemblies naturally has four wheels (two of each spider) in contact with the ground, it is much more difficult to turn the vehicle, and the turning radius is much larger than that of a conventional hand truck—which only has two wheels in contact with the ground.

There have been various approaches to addressing these and other issues. A simple approach involves inclusion of a manually-operable mechanism that mechanically locks the spiders in positions such that only two wheels (one of each spider assembly) touch the ground during rolling transport. For example, various chain-and-sprocket mechanisms have been used to achieve two-wheel locking, but they significantly increase the cost and weight of the vehicle. The chains are also under extreme tension, and can pose a reliability or safety hazard in the event of failure.

Further, mechanical pin-based systems require the tri-wheel assembly to rotate to a precise angle, at which point a locking pin is inserted to lock the assembly at an angle that allows the unit to be manually tipped onto two wheels. The main problems with the mechanical pin method are strength and complexity.

Moreover, the tri-wheel assembly must be aligned exactly prior to pin insertion, which may be difficult to accomplish without extensive user effort. The pin may also be difficult to retract under load to transition to stair-climbing mode. As with the chain-and-sprocket approach, the components are also under considerable mechanical stress, and thus will be relatively heavy and pose a significant reliability and safety issue.

The foregoing designs may use a rigid locking system, which will not tolerate shocks and impacts well. For example, it would be relatively common for the hand truck to experience impacts when rolling over curbs and other bumps. The chains or pin lock could easily experience peak stresses many, such as 5 or more, times higher than the average static stress, but the parts must be designed to withstand this peak stress. This design requirement will increase weight and production costs. A complex and expensive approach, frequently employed in passenger-carrying wheelchairs, involves inclusion of motors, sensors, and feedback-based control to cause the wheelchair to actively balance itself, relative to a vertical reference plane, on two wheels (one of each spider assembly).

There are numerous stair climbing vehicle designs that utilize a multiple-armed, wheel-supporting spider drive so as to place rotating wheel points located near the ends of the wheel's arms successively on wheel-supporting surfaces, such as a flight of stairs. Such spider wheels may be small, freely-rotating wheels fastened at the ends of spokes that rotate all together as a rigid assembly. For example, PCT Patent Publication No. W08600587A1 describes a stair-climbing hand truck utilizing rotating spider wheels.

However, even the state of the art fails to address a critical safety issue likely to arise on stairwells with a shallower rise. During stairwell descent, the spider assembly rotates continuously in the down-stairs direction, placing each of the individual spider wheels successively on each lower stair riser in a controlled manner. The spider, though, may unintentionally reverse rotation direction during descent if the lower-leaning wheel of the assembly does not become properly pinned against the inside corner of the lower riser. In such a case, weight is not properly shifted to the lower leaning wheel, allowing the lower leaning wheel to roll forward rather than remain anchored as a pivot against the inside corner of the lower stair riser. This may result in the unit falling to the lower stair riser, thus interrupting a smooth and controlled descent and potentially causing damage.

The prior art attempts to address this problem associated with descent through altering the geometrical structure of the spider assembly, proposing the use of a four-wheeled spider assembly instead of a three-wheeled one, built with predetermined dimensions to suit a stairwell of typical height. Thus crafted, the pre-dimensioned four-wheel spider avoids the aforementioned problem on a typical stairwell since its central pivot locations lie forward of the pivot center of the lower leaning wheel. However, even a four-wheeled spider thus properly dimensioned will confront the aforementioned problem on a relatively shallow stairwell outside the bounds of its geometrical design, and will exacerbate the aforementioned problems of a non-round wheel, limited turning radius, and the like.

### SUMMARY OF THE INVENTION

The stairclimbing vehicle of the invention may include a variable engagement clutch and brake system. This clutch can either lock the wheels to the same reference frame as the hand truck frame, or can allow them to spin freely. During ascent and descent modes, the clutch system may provide added driving traction to force the hand truck to climb the stairs, rather than roll off or bounce in place. The clutch also can act as a brake to lock the hand truck to the stairs, reducing the possibility that it would roll off if the user were to stop at some point during ascent or descent. In one embodiment, the clutch is electromagnetic and fully controlled by the controller; no user control is required.

The invention may further include using a friction clutch system to create a wheel that spins freely in one direction, while offering a configurable amount of slip torque resistance in the opposite direction of rotation. Further included may be a unidirectional slip clutch system for the wheels of a stair climbing hand truck to provide a forward driving and/or locking force. Moreover, the disclosure includes a slip clutch system with a low level of resistance opposing forward motion and a moderate level of resistance opposing reverse motion for the wheels of a stair climbing device. For example, in an embodiment a clutch device may allow a wheel to freely rotate in one direction while encountering a slip clutch resistance in the opposite direction of rotation.

Thereby, the present invention is advantageous at least in that it addresses the shortcomings of the known art, as discussed above.

### BRIEF DESCRIPTION OF THE DRAWINGS

The present invention will now be described by way of example with reference to the following drawings, in which:

FIGS. 1A and 1B are isometric views of an exemplary vehicle in accordance with the present invention;

FIGS. 1C and 1D are rear and isometric views of the vehicle of FIG. 1, shown with selected housings and components removed for illustrative clarity;

FIGS. 2A-2F are schematic illustrations of successive steps of the vehicle of FIG. 1 depicted during stairwell descent;

FIG. 3 shows a schematic side view of the vehicle of FIG. 1, depicted on a steep stairwell;

FIG. 4 is an operational flowchart of the vehicle of FIG. 1;

FIG. 5 is a side-view of the vehicle of FIG. 1, shown traversing horizontally in a two-contact point configuration;

FIG. 6 shows a side-view of an alternative embodiment of the vehicle with supporting stand;

FIG. 7 is a perspective view of yet another alternative embodiment o the vehicle, including two exemplary cargo platforms in accordance with the present invention;

FIG. 8 is a perspective view of the vehicle of FIG. 7, shown supporting exemplary cargo baskets in accordance with the present invention;

FIG. 9 is a perspective view of the vehicle of FIG. 7, showing the upper platform in an inoperable position, in accordance with the present invention;

FIGS. 10A-10D are perspective views of a vehicle similar to that of FIG. 7, showing a telescoping handle in accordance with an alternative embodiment of the present invention;

FIG. 11 is a schematic illustration of various components of the wheeled device, in accordance with the present invention;

FIG. 12 is a block diagram showing schematically various components of an exemplary wheeled vehicle;

FIG. 13 is a front view of a wheel integrated clutch of the present invention;

FIG. 14 is a perspective view of a wheel integrated clutch of the present invention;

FIG. 15 is a cross section view of a wheel integrated clutch of the present invention;

FIG. 16 is a perspective cross section view of a wheel integrated clutch of the present invention.

### DETAILED DESCRIPTION

It is to be understood that the figures and descriptions provided herein may have been simplified to illustrate elements that are relevant for a clear understanding of the present disclosure, while eliminating, for the purpose of clarity, other elements found in typical wheeled-vehicle apparatuses, systems and methods. Those of ordinary skill in the art may recognize that other elements and/or steps may be desirable and/or necessary to implement the devices, systems, and methods described herein. However, because such elements and steps are well known in the art, and because they do not facilitate a better understanding of the present disclosure, a discussion of such elements and steps may not be provided herein. The present disclosure is deemed to inherently include all such elements and steps, and all variations and modifications to the disclosed elements and methods that would be known to those of ordinary skill in the pertinent art.

The present invention relates generally to stair-climbing wheeled vehicles, and more particularly to electrically-powered, and/or spider-driven, and/or stair-climbing wheeled vehicle having a microprocessor-controlled mode or modes for facilitating balancing and maneuvering of the vehicle. The present invention is applicable to hand trucks, luggage carriers, wheel chairs, baby carriages and/or other wheeled vehicles. A wheeled vehicle in accordance with the present invention includes sensors, an electric motor, and a controller for controlling the motor as a function of input received from the sensors to provide modes for facilitating balancing, including facilitating manual balancing, and maneuvering of the vehicle.

Unlike principally mechanical designs, the approach of the present invention includes principally electronic control. Further, the disclosed embodiments do not require any significant addition of components or production costs, and avoid end user complexity.

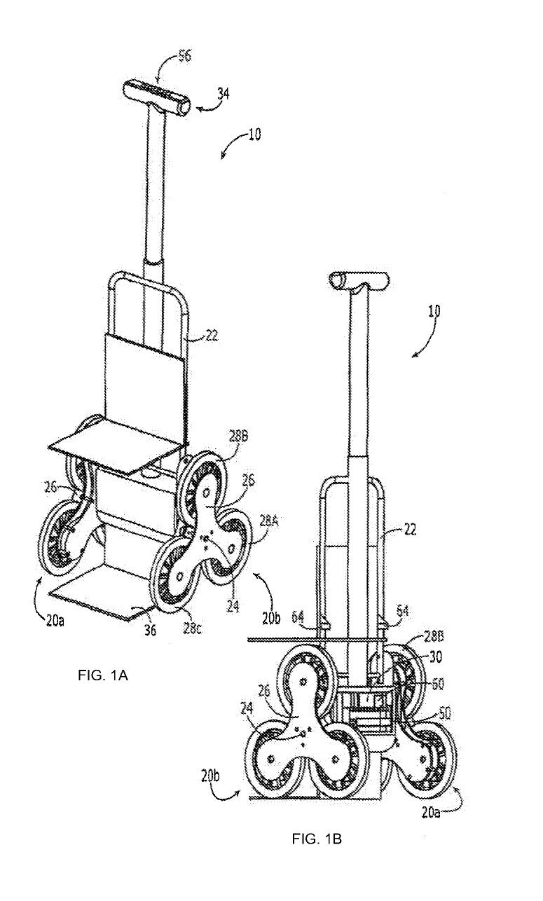

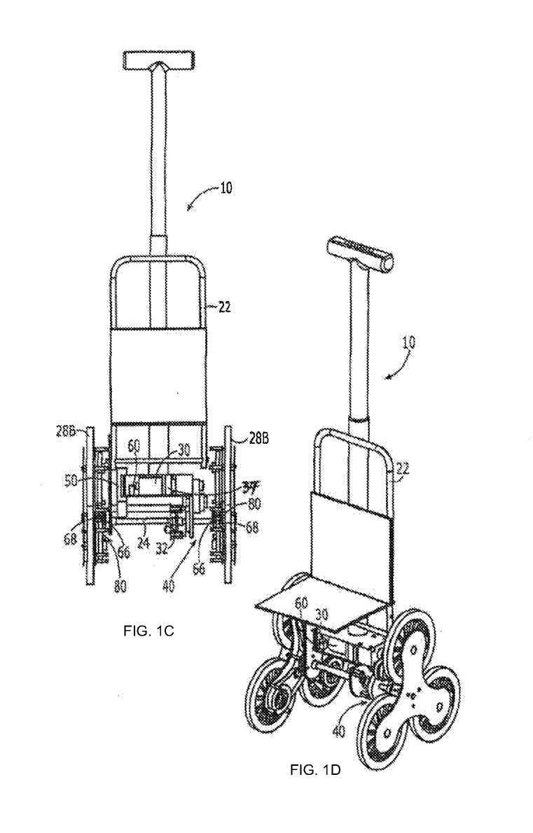

For illustrative purposes, the present invention is discussed in the context of an exemplary hand-truck vehicle, which is shown in FIGS. 1A-1D. As will be appreciated from FIGS. 1A-1D, the hand-truck includes a rigid frame 22 supporting a rotatable axle, or shaft, 24. The frame supports a load-bearing nose, or platform, 36 of a type typical of conventional hand trucks, and a user handle. Symmetrically fixed adjacent both ends of the axle 24 are spider assemblies 20a, 20b, each having a hub 26 supporting equally-spaced rotatable wheels 28A, 28B, 28C in a star-like configuration. A geared motor 30 and battery 50 are supported on the frame 22. The motor 30 and battery 50 are operatively connected, and the motor 30 is operatively connected to the axle 24 by gear train 40 (FIG. 1C) so that rotational torque may be applied by the motor 30 to cause the spider assemblies 20a, 20b to rotate both clockwise and counterclockwise about an axis of axle 24 while frame 22 remains fixed. Angle sensor 32 measures the angle formed between frame 22 and spiderwheel assembly. User handle 34 may be located at the top end of 22 while a load-bearing nose 36 is preferably attached above spiderwheel assemblies to 22.

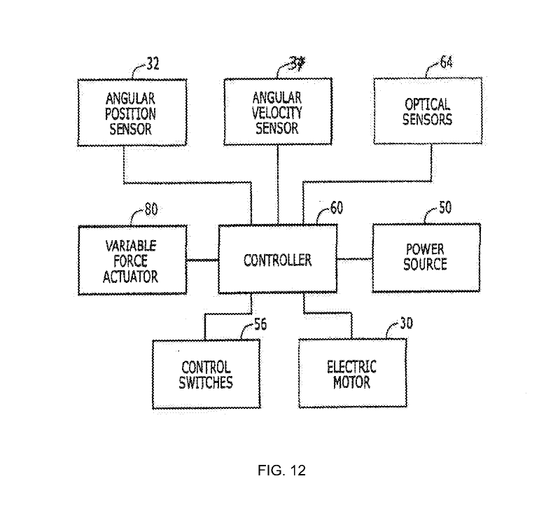

The vehicle 10 includes a microprocessor-based controller 60 configured to receive input from various sensors discussed throughout, and to control operation of the motor's driveshaft as a function of the input received, as shown in FIGS. 1C, 1D and 12. For example, the controller 60 includes a memory storing software (microprocessor-executable instructions) in accordance with the present invention to dynamically vary the current supplied to the motor as a function of the input received from the sensors, as discussed below.

The wheels of each spider assembly 20a, 20b may be operatively coupled to rotate in synchronicity, e.g., by gears 70 fixed to rotate with each wheel 28A, 28B, 28C and coupled by a double-sided timing belt 72, as shown in FIGS. 1D and 11. The belt 72 is restrained by idler pulleys 74 to retain the belt 72 within a footprint of the hub 26. The belt 72 engages a clutch 80 that is controlled by the controller 60 to selectively engage, to cause the wheels 28A, 28B, 28C to be driven by the motor 30 to rotate in synchronicity, or to disengage, to permit the wheels to rotate freely in synchronicity. Of course, those skilled in the art will appreciate other modes of synchronization and rotation in light of the discussion herein.

The vehicle 10 may further include a variable-force actuator 80, such as an electromagnetic clutch, that provides a variable braking force to rotation of the wheels 28A, 28B, 28C about their respective axes. The variable-force actuator 80 is operatively coupled to the controller 60, which controls current supplied from the power source, and that thus controls the amount of braking force applied. See FIGS. 11 and 12. In one embodiment, the electromagnetic clutch 80 includes a coil that is powered by a pulse width modulation circuit controller by the controller 60, allowing a variable level of slip torque to be set. The slip level is important, since the clutch should be allowed to slip when maximum torque levels are reached, reducing the probability of overload or breakage.

As illustrated with particularity in FIGS. 1C and 11, an electromagnetic clutch 80 may consist of two primary components: a fixed electromagnetic plate 66; and a rotating actuator plate 68. The electromagnetic plate 66 may be fixed to the frame 22, while the rotating actuator plate 68 may be supported on the main axle 24 so that it may freely rotate relative thereto. The movable clutch plate may be operable to “lock” the central drive pulley to the frame 22 with variable slip torque. The variable force is generated by variation in voltage applied to the electromagnetic plate 66 under control of the controller 60. The rotating plate 68 may be integrated into the timing pulley and belt system, such that it rotates synchronously with the wheels 28A, 28B1 28C on each spider assembly 20a, 20b, as best shown in FIG. 11.

When engaged, the clutch 80 provides a variable torque between the rotating plate 68 fixed with respect to the wheels (rotatable relative to the axle 24) and the fixed plate 66 fixed to the frame. The clutch 80 locks the central pulley to the frame 22 with variable force. As the wheels and spider hubs 26 rotate around the locked central pulley, the wheels 28A, 28B, 28C are driven to rotate with relation to the frame 22, while they translate in a rotational arc based on the driving of the hubs 26 by the main axle 24. Thus, the wheels are caused to rotate with respect to the frame 22 while the spider assemblies 20a, 20b rotate around them, resulting in a net forward driving force that forces the vehicle 10 into abutting relationship with the base of the stairs, instead of allowing it to fall off or bounce in place. When the wheels of the spider assemblies contact the riser of the next stair, the vehicle can no longer be driven further into the stairs, and the clutch 80 slips to limit the torque on the pulley system.

In accordance with the present invention, the vehicle 10 may further include an angular position sensor 32 (see FIG. 1C) that is mounted to sense an angle formed between frame 22 and spider assembly 20a (e.g., a reference portion of hub 26). By way of example, an absolute optical encoder or an absolute “magnetic rotary encoder may be used as the angular position sensor 32. The angular position sensor 32 is mounted to sense the angular position of the spiders relative to a remainder of the frame 22, and to provide angular position feedback to the controller 60. By way of example, the angular position sensor 32 may be fixedly mounted to the axle 24 in position to read markings on the hub 26 as it rotates. Alternatively, the sensor 32 may be integrated into the gear train 40, as will be appreciated by those skilled in the art. Optionally, the vehicle 10 further includes an angular velocity sensor 37 (see FIGS. 1C and 12), such as an incremental optical encoder. The angular velocity sensor 37 may be mounted on the frame 22 (or shaft 24) to sense the angular velocity of rotation of the axle 24 (and thus the hubs 26) and to provide feedback to a the controller 60, which is capable of controlling operation of the motor's driveshaft, as discussed in greater detail below. By way of example, the incremental optical encoder 37 can either be mounted on the main axle 24, or on the motor's shaft, e.g. before the gear train 40. The incremental optical encoder 37 provides a much faster and responsive measurement of velocity than measuring the change in the angular position sensor over time.

The vehicle 10 may further include user-operable switches 56 mounted on the handle 34, as shown in FIG. 1A. The switches 56 may be user-operable to select from among ascent, descent, transport and stop operational modes of the hand truck, each of which provides input to the controller and governs how the controller will control the motor, etc. In one embodiment, transport mode is automatically selected by operation of a main power switch, and the stop mode is selected automatically by deselection of either ascent mode or descent mode. The ascent mode and descent mode switches may be momentary spring types, such that all automated operation of the spider assemblies ceases if the user releases the handle 34 or releases one of the switches 56.

The controller 60 is programmed to control operation of the hand truck in the various modes. More specifically, controller 60 is configured to control current supplied to electric motor 30 from power source 50 as a function of input received from one or more of angular position sensor 32, velocity sensor 34, optical sensors 64, and switches 56, in accordance with microprocessor-executable instructions stored in the memory of microprocessor-based controller 60. See FIGS. 1C and 12. Differing instructions are provided for the various modes of operation.

Transport mode is used for transporting items, such as water jugs, pallets, cases, luggage, etc. over a substantially level flat or inclined but flat floor, etc. In this mode, the controller 60 causes the variable-force actuator (electromagnetic clutch) 80 to disengage, and thus permits the wheels 28A, 28B, 28C to rotate freely. The controller 60 receives data from the angular position sensor 32 and causes the motor to rotate the spider assemblies (hubs 26) to one of several (three for a tri-wheel spider assembly, spaced by approximately 120 degrees) predetermined angular positions relative to the frame, and to fix the spider assemblies in the selected angular position. The angular position is such that the vehicle rests with the frame 22 in a substantially upright position, with four wheels (two of each spider assembly) resting on the ground. Upon inclining frame 22 to traverse horizontal surfaces, the spider assembly hub 26 and frame 22 tilt as one fixed unit, the angle between the hubs 26 and the frame 22 being fixed, at which point only two wheels (one on each spider) are positioned to contact the floor during rolling transport of the hand truck. The controller 60 continues to receive angular position data from the angular position sensor 32 as feedback, and to control the motor 30 by varying current from the power source to the motor, to fix the hubs 26 in the selected angular position, e.g. to maintain the predetermined angular relationship between the spiders and the frame, regardless of the position or orientation of the frame/hand truck relative to the floor, or a vertical plane.

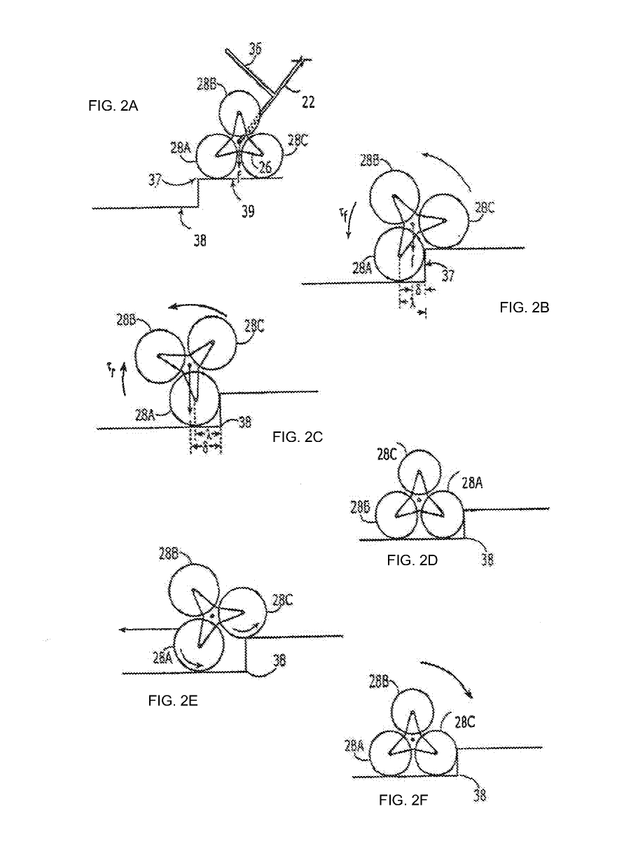

More specifically, the controller 60 uses the angular position sensor 32 to determine the current angle between the hubs 26 and the frame 22, and sets the target angle to the nearest of several acceptable points (one corresponding to each wheel of the tri-wheel assembly). The motor 30 is actively controlled through bi-directional pulse width modulation (PWM) to maintain the target angle. The controller uses a proportional integral derivative (PID) control loop to maintain a stable angular position of the spider assembly hubs. Gradual power ramping is used to prevent any sudden movements or jerking. Accordingly, the relative angular position of the hubs 26 and frame 22 is maintained substantially constant, the frame and hubs tilt as a unit, and the hubs are “fixed” relative to the frame. The unit's turning radius is thus greatly reduced, enabling the turning of tight corners. The locking mechanism may then be disengaged prior to ascent and descent, allowing for the free rotation of the spider wheel as depicted in FIG. 2A.

Thus, regardless of the hand truck's spatial orientation/inclination relative to a vertical plane, etc., the controller, angular position sensor, motor and power source may cooperate to maintain a fixed angular position of the hubs 26 relative to the frame 22 in fixed mode.

By way of non-limiting example, in ascent mode, the leading wheels of the tri-wheel assembly are likely to impinge upon the riser of the step rather than roll onto the tread pull if the angle has changed significantly from when the user was standing on the ground. To correct the angle and place the two leading wheels on the stairs, controller 60 may rotate the spider assembly hubs 26 to an appropriate angular position for starting ascent, and may use feedback from the angular position sensors 32 to vary the current/torque applied to the motor 30 to fix the hubs in the appropriate positions relative to the frame 22. The appropriate angular positions position the leading wheels to ensure that they will not interfere with a next step during ascent. In contrast, in transport mode, the angular positions may be selected to reduce torque required to fix the hubs relative to the frame by keeping the points of ground contact relatively close to the center of mass (or expected center of mass) of the loaded hand truck, to reduce motor power consumption and to extend battery life. Accordingly, use use of the controller and electronic components avoid stress on, and possible failure of, mechanical components.

Further, in ascent mode, the controller 60 may cause the variable-force actuator to provide a moderate amount of braking force, e.g., 0-15 inch-pounds of torque or 0-4 pounds of driving force at the contact points of the wheels, to prevent free-spinning of the wheels, to effectively lock rotation of the wheels. This driving torque adds a horizontal component to the force exerted on the stairs, causing the hand truck to “hug” the riser of each stair. Without this force, the spider assembly would tend to exert only a sinusoidal force in the vertical direction, providing no motivation to ascend the stairs without the user's pulling of the unit against the riser of each next stair, and if the user did not pull consistently, the unit could skip a step, bounce in place, or fall down the stairs. Additionally, the controller 60 causes the motor to drive the spider assemblies to rotate in an ascent-appropriate direction. This locking of the wheels facilitates stability during climbing of stairs as the spiders rotate. The moderate amount of braking force also allows a limited amount of slipping during climbing to allow rotation of the wheels about their axes when a wheel abuts a tread/riser juncture of a staircase, and the associated spider continues to rotate. The controller 60 senses the speed of rotation of the spiders (as determined directly by the velocity sensor 34 or indirectly from data provided by the angular position sensor 32) and controls the motor to vary the spider rotation speed to maintain a substantially constant speed of ascent. In will be noted that the vehicle 10 may or may not attempt to balance itself, but rather may rely upon a person climbing the stairs to guide the hand truck and to provide stability as the hand truck climbs the stairs.

In one embodiment, the vehicle includes stair sensors 64, as best shown in FIG. 1B. Each stair sensor 64 may be a commercially-available infrared optical range finder. The vehicle may be configured such that each stair sensor 64 is used to measure a distance from a fixed point on the frame 22 to the nearest surface in a location slightly behind the frame, where a step would likely be encountered prior to starting ascent. The controller 60 is preferably configured to prevent the spider assemblies from rotating, even if ascent mode is selected by the user using the switches 56, if the vehicle 10 is not actually on or adjacent to stairs. Thus, the controller 60 is configured to prevent operation of the spider assemblies in ascent mode, even if ascent mode is selected by the user via the switches 56, if the stair sensors 64 do not detect an adjacent step. In one embodiment, a pair of optical rangefinders 64 is mounted to the frame approximately 1.5 feet above the ground. These sensors 64 both point downwards and measure the distance from a fixed reference point to the nearest surface. If the distance value decreases by a preset threshold amount, it is likely that the vehicle is in proper position adjacent a step, and the controller will permit the vehicle to enter ascent mode. The use of two or more sensors decreases the likelihood of a false reading due to a user's foot or clothing, by requiring both/all sensors to confirm adjacent step presence simultaneously before permitting driving of the spiders in ascent mode.

If an adjacent step is not detected, the vehicle may not drive the spider assemblies in an attempt to ascend, but will remain in ascent mode until cancelled by the end user. After the first step is detected by the sensors, the controller will cause the motor to drive the spider assemblies and the vehicle will climb as long as the ascent button is held or until ascent mode is otherwise canceled. If the user decides not to ascend the stairs, the vehicle may be returned to transport mode by briefly pressing the descent button or another appropriate one of the switches 56.

In descent mode, the controller 60 may cause the variable-force actuator 80 to disengage, and causes the motor 30 to drive the spider assemblies 20a, 20b to rotate in a descent-appropriate direction. In this mode, the controller 60 senses the angular position of the spider assemblies 20a, 20b relative to the frame 22, and causes the motor 30 to accelerate rotation of the spiders through each of three predefined zones of angular positions of the spiders relative to the frame. These zones correspond to zones of instability in which the center of gravity of the loaded hand truck tends to be positioned toward the upstairs side of the axis of rotation of a leading wheel on a lower stair tread. For example, each zone may span angular positions of a respective arm of the spider from a position −10 degrees from vertical to a position +5 degrees from vertical. Due to the weight distribution, the loaded hand truck has a greater tendency to roll along the tread and down the stairs in an unstable manner, than to descend the stairs in a controller manner by rotation of the spiders in these zones of instability. Accordingly, the rapid rotation of the spiders through these zones minimizes any related instability. This rotation has relatively little impact on descent speed, and a substantially constant descent speed is nevertheless maintained.

The controller 60 may be configured to provide alternating climb-down and climb-up oriented torque on the spider assemblies during stairwell descent responsive to the absolute rotation angle of the spider assemblies relative to the frame 22. This helps to ensure that the leading wheel remains pinned against the inside corner of a tread/riser interface, thus eliminating the possibility of unintended backward rotation, without imposing any restrictions on the geometry or dimensions of the spider assembly to suit any specific stairwell height. As a result, an advantage is gained that allows for any spider assembly configuration, including a three-wheeled configuration, to properly descend stairwells of any riser height.

The spider assembly 20a, 20b may be selectively driven either clockwise or counterclockwise by the motor 30. The controller 60 may be configured to vary motor power based on feedback from the velocity sensor 34 and the absolute angular position sensor 32 to regulate climbing and descent speeds. Since the loading torque on the spider assemblies may be sinusoidal, both climbing torque and descent braking alternate in a sinusoidal pattern such that the rotation speed may be maintained substantially constant even though the loading torque and motor power follow a counteracting sinusoidal pattern. Accordingly, in descent mode, the controller 60, angular position sensor 32, angular velocity sensor 34, motor 30 and power source 50 may cooperate to cause acceleration of rotation of the hubs 26 through zones of instability, as predefined and stored in the memory of the controller. This reduces the length of time that the leading wheel is ahead of the center of mass of the hand truck, and thus reduces the length of time that the hand truck remains in an unstable state.

By way of example, in transport mode, the target angle may be such that the center of mass is located approximately directly over the center of wheel contact when the frame I tilted for transport, such as approximately 20-45 deg off the vertical. In ascent mode, the target angle may change by about 5-15 degrees to ensure the leading wheels clear an adjacent stair.

While ascending or descending stairs, a user may wish to stop the vehicle so that the user may climb, descend or rest. The controller 60 is preferably configured such that if the ascent button is released while the vehicle is still ascending or descending stairs, the vehicle must stop and rest at a stable angle until the user is ready to either ascend or descend. Accordingly, the vehicle may be configured to enter a stop mode in this event.

In stop mode, the controller 60 causes the motor 30 to drive the spider assemblies 20a, 20b to continue to rotate to one of three predetermined angular positions, as determined by feedback provided by the angular position sensor 32. Although the hubs 26 can be stopped and electronically fixed (by the angular sensor/motor feedback loop) at any desired angle, it is particularly stable to stop rotation of the hubs in predetermined positions such that two wheels of the vehicle rest on a lower tread and another two wheels rest on the tread of the next higher step, and the hand truck is positioned in a substantially upright position. The predetermined positions are defined as positions at which the hand truck is expected to stand in a stable manner on stairs of a staircase.

It will be noted that even when ascent or descent has stopped and the spider assemblies have ceased to rotate, the vehicle could roll down the stairs if the user were not to provide adequate holding force. To eliminate such rolling, the controller may cause the variable-force actuator 80 to engage (and prevent free-spinning of the wheels 28A, 28B, 28C) to provide a significant amount of locking force that locks the wheels into position and prevents the hand truck from rolling off of the stair treads when a predetermined position is reached. This permits the hand truck to maintain its position, on a stair case, during either ascent or descent of stairs.

For example, to operate the unit on horizontal surfaces or stairwells, frame 22 may be inclined with respect to the horizontal at the aforementioned predetermined angle (as depicted in FIG. 2A), such as by a user gripping handle 34. Weight resting on 36 produces a downward-directed force, f, on the center of spider assembly 26. For the purposes of illustrating spiderwheel orientation during descent, triangularly symmetric wheels 28A-C are labeled separately in FIGS. 2A-F. As depicted in FIG. 2A the unit starts on a higher riser approaching lower riser 38. Lead wheel 28A then rolls over the corner of the higher stair causing the 26 to rotate about its center until 28A makes contact with lower riser 38. As depicted in FIG. 2B horizontal distance, .delta., as measured from the inside corner of 38 to the center of rotation of 26, is less than horizontal distance, .lamda., measured from the center of 28A to inside corner of 38, so that force f produces a clockwise-oriented moment around 26. Since .delta.<.lamda., weight has not shifted appropriately to cause 26 to pivot in the climb-down direction around the center of 28A. Instead, 28A rolls forward as in FIG. 2E, causing 28C to fall suddenly to 38 and the spiderwheel assembly to back turn as depicted in FIG. 2F.

To avoid this scenario, a forward torque .tau..sub.f may be applied by the geared motor in the case that .delta.<.lamda., i.e., when the center of 26 is not horizontally to the left of the center pivot point of 28A. Since 22 is kept at a constant level of inclination with respect to the horizontal, and angle sensor 32 measures the angle formed between 22 and 26, 22 effectively measures the orientation of 26 in relation to the horizontal by transitive property. 32 is thus able to verify when the condition .delta.<.Iamda. holds. As .tau..sub.f is applied, 26 rotates counterclockwise about the central point of 28A until .delta.>.Iamda. as depicted in FIG. 2C. When the condition .delta.>.lamcla. holds, force f produces a counterclockwise-oriented moment around 28A, continuing the direction of rotation of 26. A clockwise-oriented reverse torque .tau..sub.r is then applied in order to slow the velocity of rotation of 26 about the center of 28A. Reverse torque is applied until 26 has reached the flat orientation as depicted in FIG. 2D. Flat orientation is verified by 32. Wheel 28A remains abutting 38 while wheel 28B is forward of 28A resting on the lower riser, whereas in the alternate situation attempting to be avoided depicted in FIG. 2F, wheel 28C has fallen to about 38 while 28B does not contacting the ground. Having completed 120.degrees. of rotation, the unit is once again in the original orientation depicted in FIG. 2A, ready to travel on flat ground or descend another stair in a similar manner as described.

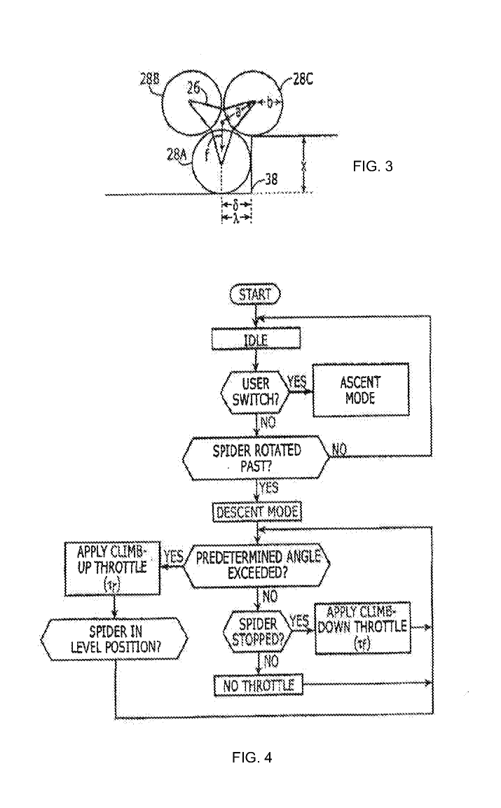

Higher stair risers may be encountered, as depicted in FIG. 3, wherein riser height x, distance a, from center of 26 to the center of each wheel, and wheel radius b satisfy the relationship: x>b+a+1/2a−b, or more simply, where x>3/2*a. In this situation, forward torque .tau..sub.f need not be applied during descent since the condition .delta.>.Iamda. is avoided. FIG. 4 depicts the unit operation in a flowchart as previously described.

One advantage of the foregoing embodiment allows for the geared motor 30 to allow for continued rotation of the spiderwheel assembly until a predetermined position is attained where at least two of the wheels 28A-C will abut a surface. In an unstable position such as that depicted in FIG. 2C, wherein only one wheel remains abutting a surface, should the user let go of an engagement switch indicating a preference to stop mid-stairwell during ascent or descent, the microprocessor will allow for continued counterclockwise-oriented rotation until the orientation in FIG. 2D is reached, whereupon the motor applies a nominal clockwise-oriented torque to the spiderwheel, thus locking the spiderwheel in an attained position.

Individual stages of the vehicle depicting ascent up stairs are referred to in the reverse sequence FIGS. 2D-A. Referring to the spiderwheel orientation in FIG. 2C, should the user decide to disengage the trigger means for ascent, the unit appropriately continues clockwise-oriented rotation until lead wheel 28C rests on the higher riser surface as depicted in FIG. 2B, before the motor locks the unit in the attained position as previously described by applying a nominal clockwise-oriented. Thus two separate orientations as depicted in FIGS. 2B and 2D may provide stable locking positions, i.e., wherein two of the three wheels remain abutting a stairwell surface.

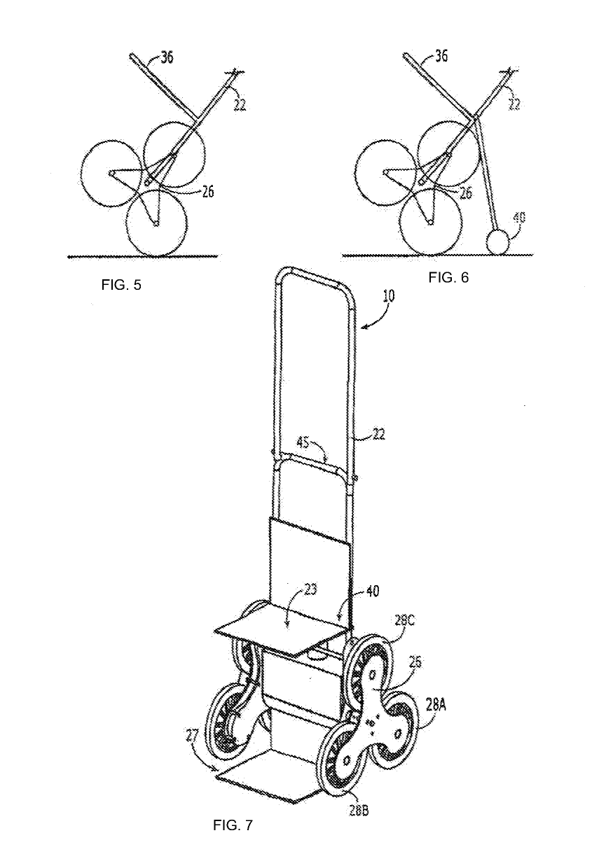

The spiderwheel may also employ an optional locking mechanism, such as a latch, hand brake, mechanical clutch, or electronic brake, to disallow spiderwheel rotation in relation to frame 22 when the unit is resting on a horizontal surface with the two of the three wheels resting on the ground. For example, upon inclining frame 22 to traverse horizontal surfaces, the spider assembly and frame may tilt as one fixed unit, allowing only two of the wheels to contact the ground rather than four as depicted in FIG. 5. The unit's turning radius is thus greatly reduced, enabling the turning of tight corners. The locking mechanism may then be disengaged prior to ascent and descent, allowing for the free rotation of the spider wheel.

An additional set of wheels may be attached to a support stand 40 that is mounted to frame 22 to pivot between an inoperative position, and an operative positions facilitating horizontal traversal as depicted in FIG. 6. The vehicle may be also equipped with a load-measuring scale that interacts with the controller to adjust motor output as a function of varying loads on the frame. Also, the various components discussed throughout may be constructed of any material with sufficient strength and rigidity to bear the intended loads, such as steel.

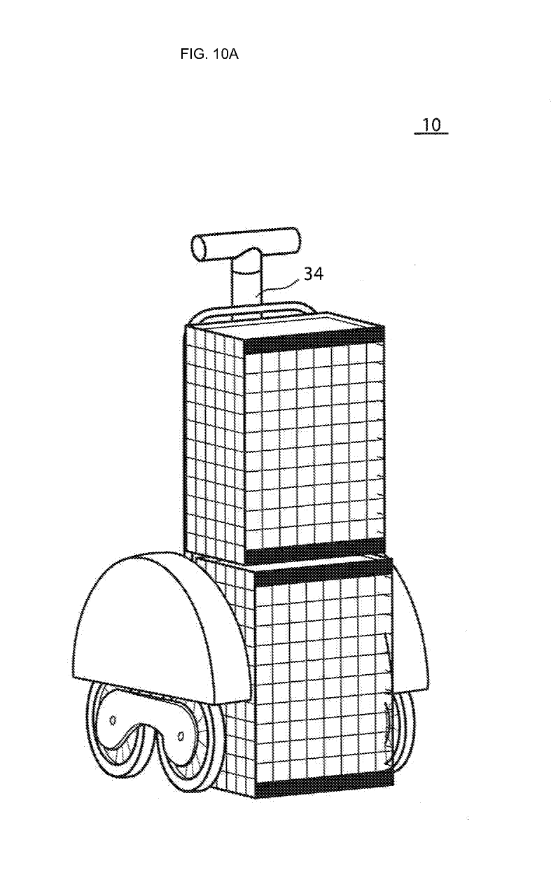

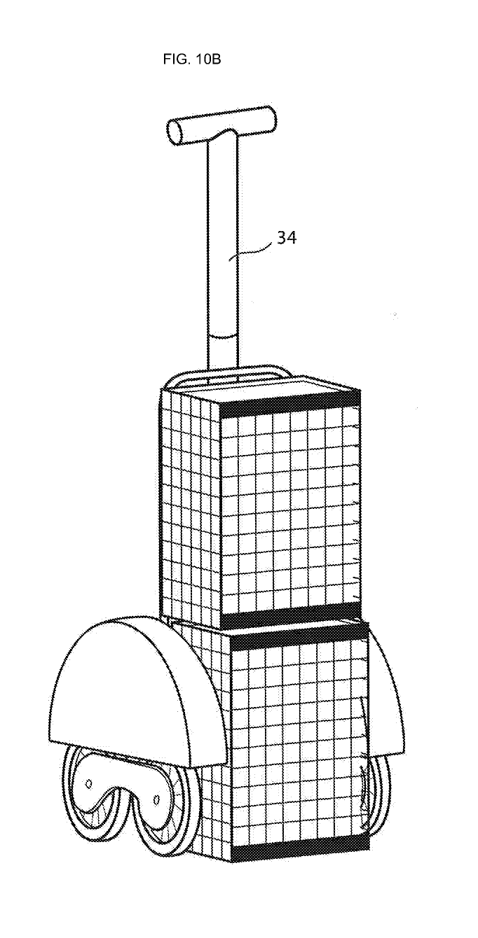

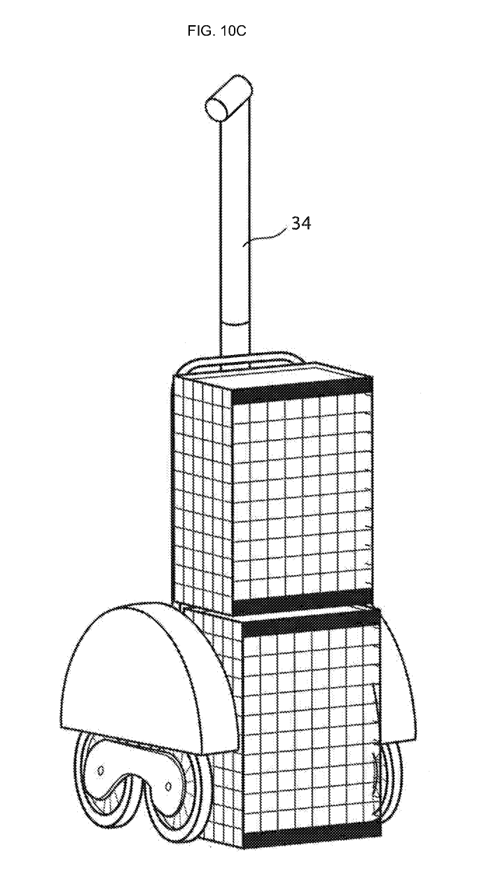

In certain embodiments, the wheeled vehicle is configured as a hand truck 10 including a fixed or foldable base platform, a secondary foldable upper platform, and detachable cargo baskets, as best shown in FIGS. 7-9. The hand truck's stair-climbing components are similar to those described above with reference to FIGS. 1-6. Referring now to FIG. 7, there is shown a rigid hand truck frame 22, a rigid foldable upper platform 23, platform hinge mechanism 40, basket attachment point 45, and lower platform 27. In more detail, still referring to the exemplary embodiment of FIG. 7, the foldable upper platform 23 can pivot on hinge 24 and can be fixed either in a direction parallel to the frame 22 (see FIG. 9) or perpendicular to the frame 22 (see FIG. 7). Thus, it will be appreciated that the folding upper platform can be folded out of the way (against the frame 22 as in FIG. 9) such that a tall load may be carried on the lower platform without interference.

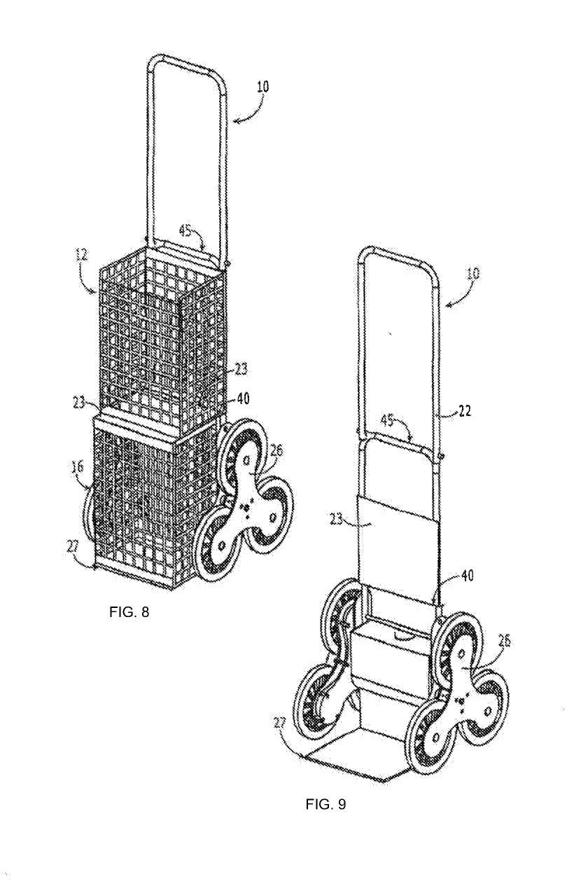

Referring now to FIG. 8, the hand truck 10 of FIGS. 7 and 9 is shown with an upper basket 12 and a lower basket 16 supported on the upper and lower platforms 23, 27, respectively. The baskets allow odd shaped or unstable loads to be constrained for safe transport, while being removable for larger loads. The upper basket and lower baskets 12, 16 can easily be attached or removed from frame 22 by mounting hooks of the baskets onto the frame, and allowing the baskets to hang from the frame. Preferably, the lower basket 16 is designed such that it fits within the confines of frame 22 and avoids contact with any moving parts of the hand truck. The upper and lower baskets are preferably constructed of a lightweight, crack-resistant material capable of meeting the strength requirements, such as any one of a variety of plastic materials.

Thus, in the exemplary embodiment of FIGS. 7-9, the hand truck includes a platform 23 that is mounted on the frame 22 to be pivotable between an inoperable position, in which it lays against the frame of the hand truck, and an operable position, in which it extends substantially perpendicularly to the frame of the hand truck, and substantially parallel to a load-bearing platform 27 of the hand truck. In the operable position, the platform may be used to support a load, such as a box of heavy items, without need for stacking on any items positioned on the longer platform. The platform may be pivoted to the inoperable position to permit carrying of larger items on the lower platform 27, such as a golf bag, without interference with the platform. Further still, the frame may be configured with attachment points for supporting one or more removable baskets, each of which may be used to separately carry items, without a need for stacking the items upon one another on the platform. For example, a lower basket 16 may be carried on the lower platform 27, and a large box may be carried on the upper platform 23 pivoted to the operable position.

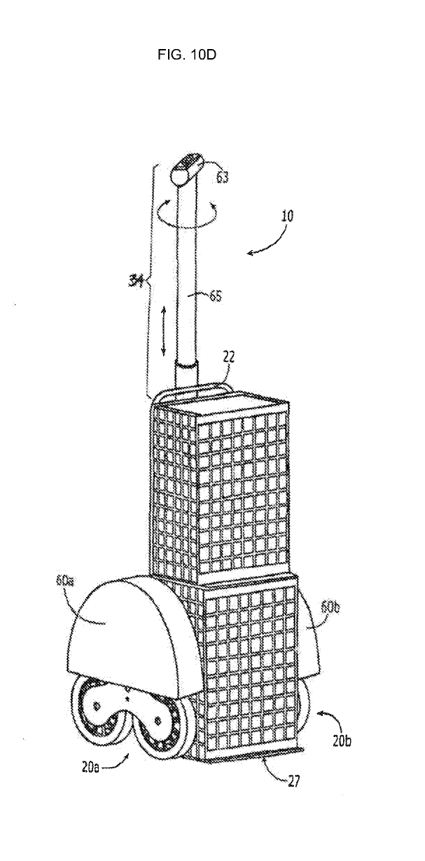

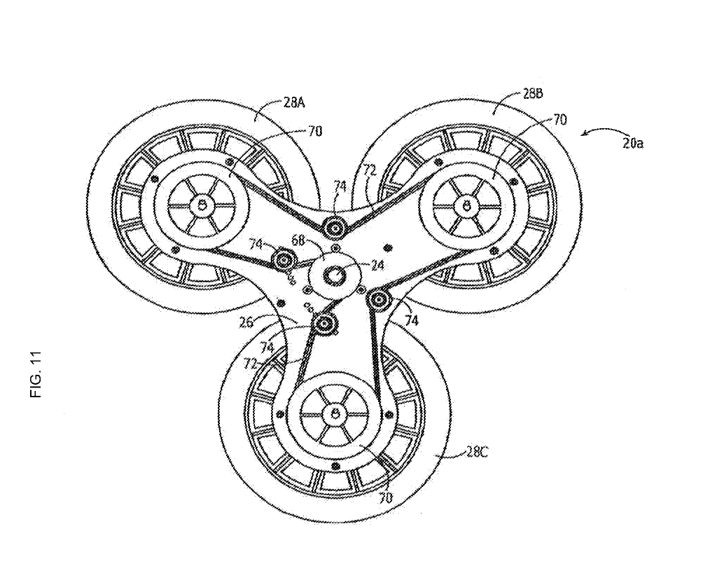

The wheeled vehicle 10 may further include a telescoping, rotating one of the control handle 34 supported on the frame 22, as shown in FIGS. 10A, 10B, 10C and 10D. The handle 34 consists of an ergonomic handle member 63 attached to a rigid shaft 65, which can both rotate and extend telescopically from a metal tube attached to the frame of the hand truck. The handle 34 may be adjusted by the user to whatever height is desired. The handle member 63 and telescoping shaft 65 can then be locked using a conventional locking mechanism, such as spring biased detent mechanisms, clamps, etc., such that further linear extension or retraction is prevented, while still allowing rotation to occur. The rotation feature improves ease of use by allowing the user to stand to either side of the unit while ascending or descending stairs without having to hold the handle at an uncomfortable angle. The control wires for the user interface may extend through the hollow handle member and/or hollow shaft 65. The handle may be limited to only 120 degrees of rotation by mechanical stops to prevent the internal wires from being excessively twisted or otherwise damaged.

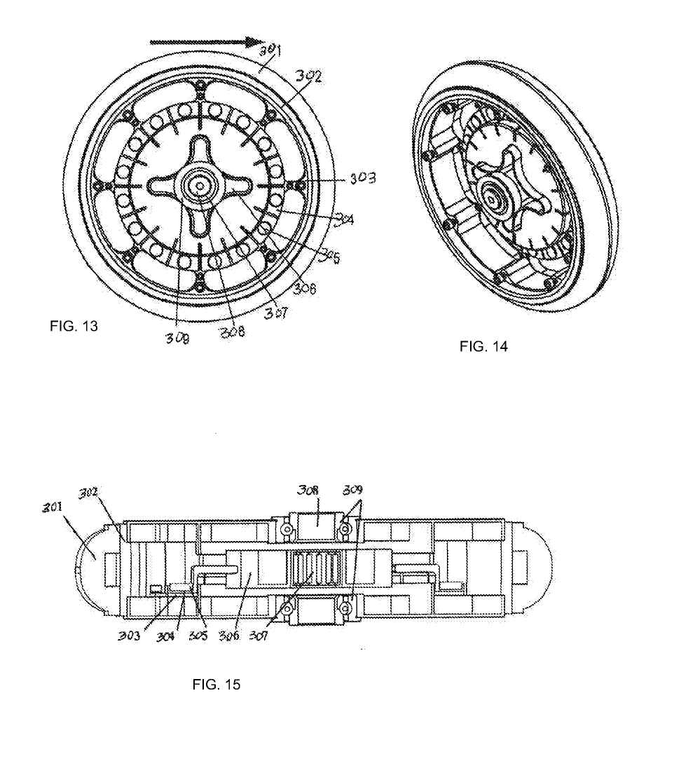

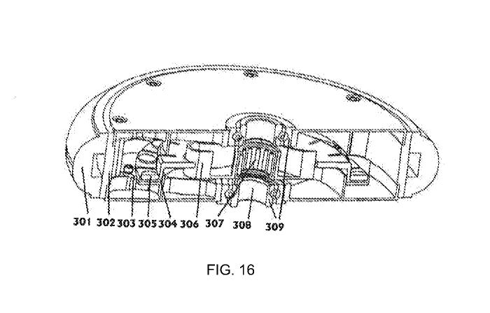

In an additional embodiment of the clutch, illustrated in FIGS. 13-16, there is shown an exemplary clutch system, which may be employed with spider-wheeled or simple-wheeled embodiments of hand trucks, such as those discussed. hereinthroughout. There is shown a tire 301, a wheel rim 302, a clutch plate 303, a brake pad 304, a magnet or spring assembly 305, a cam driver 306, a one way roller clutch 307, a shaft 308, and a ball bearing 309.

In more detail, referring to the invention of FIG. 13, the clutch device functions by roller clutch 307 and ball bearing 309 creating a unidirectional bearing, which spins freely on fixed shaft 308 in one direction, but which is fully locked in the opposite direction of rotation. The locking mechanism functions through the use of a one way needle roller bearing clutch 307, which may be any commonly available type of bearing. The roller elements are housed by a plastic cage which allows them to roll freely as the wheel rotates in the direction indicated by the arrow above FIG. 13, but when the wheel is rotated in the opposite direction of the arrow, the roller bearing elements are guided up a ramp like structure in a plastic cage inside the bearing which causes them to jam tightly against the surface of shaft 308, preventing motion.

The shaft 308 does not rotate and is rigidly mounted to an external structure, which results in the outer races of roller clutch 307 and ball bearing 309 rotating around the stationary inner races and shaft. Cam driver 306 is coupled to the unidirectional bearing system and can likewise rotate freely in one direction around shaft 308. The cam driver 306 is a cloverleaf shaped structure that engages brake pad 304 and provides transfer of torque without overly restricting free motion in the axial direction. Brake pad 304 and magnet! spring assembly 305 are driven by cam driver 306 and create a friction drive against clutch plate 303, which is bonded to wheel rim 302 and tire 301. The device functions by allowing the assembly to spin freely in one direction relative to fixed shaft 308, while providing a constant friction torque resistance in the opposite direction.

In further detail, when the tire 301 and wheel rim 302 rotate in the direction shown by the arrow at the top of the figure, clutch plate 303, brake pad 304, and magnet/spring assembly 305 all also rotate in the same direction. Cam driver 306 is rotated around stationary shaft 308 in the direction permitted by roller bearing clutch 307. No back torque is applied to resist the motion, and the wheel freely rotates.

When the wheel rotates in the direction opposite of the arrow in FIG. 13, tire 301, wheel rim 302, and clutch plate 303 still rotate with the wheel, but cam driver 306 is no longer free to rotate around stationary shaft 308 due to the locking action of roller bearing clutch 307, which is no longer being driven in the free direction and locks against shaft 308. Cam driver 306 is held stationary relative to shaft 308, and therefore the interlocking brake pad 304 is also held stationary relative to the shaft. Clutch plate 303 rotates along the surface of brake pad 304, but is opposed by the resistance created by magnet or spring assembly 305 which holds brake pad 304 tightly against clutch plate 303. The wheel is still permitted to rotate, but a substantial torque is created by friction of brake pad 304 against clutch plate 303. This creates a partial locking action of the wheel in the direction opposite the arrow of FIG. 13, but still allows motion if enough force is applied to overcome the static friction set by magnet or spring assembly 305 of brake pad 304 against clutch plate 303.

The wheel rim 302 and tire 301 may be sized appropriately for a stair climbing hand truck wheel. Magnet/spring assembly 305 can be manufactured to provide a wide range of slip friction by changing the strength of the magnets or spring constant of the springs. Increasing spring or magnet force will increase the torque level at which the friction plate assembly starts to slip, which can be used to provide additional locking and roll-back resistance to the wheel assembly. Too much force may result in added difficulty in maneuvering the unit in the backwards direction, so the clutch force must be optimized carefully for the application.

The construction details of the invention, as shown in FIGS. 13-16, include that the tire 301. may be made of a non-marking rubber compound, wheel rim 302 may be made of plastic or metal, clutch plate 303 may be made of steel or other metal, brake pad 304 may be made of plastic or composite material, magnet or spring assembly 305 may be made of rare earth magnets or metallic springs, cam driver 306 may be made of plastic or metal, one way roller clutch 307 may be made of steel, shaft 308 may be made of steel or aluminum, and ball bearing 309 may be made of steel. The brake pad 304 generates a small amount of heat through friction on clutch plate 303, so this must be taken into account for material selection and implementation.

Thereby, when the triwheel assembly rotates, a vertical climbing force is generated to lift the stairclimber and load. More particularly, if the three wheels were completely free spinning on their respective axes, the stairclimber would be prone to bouncing up and down and could potentially fall off the edge of the stairs. Alternatively, if the three wheels axes were “hard” locked to the triwheel hubs, the stairclimber would walk up the stairs and generate a large amount of horizontal driving force in addition to vertical force. While this large amount of horizontal drive force would ensure the unit was always pressed against the stairs, it could also cause the unit to seize up, jam into the stairs, rip carpeted stairs, or skid the wheels as the unit tries to drive into the base of the stairs a greater distance per rotation than the average tread length.

Thus, an exemplary solution provided in this alternative clutch embodiment is to provide a one direction slip clutch that allows the unit to freely roll towards the user (towards the stairs), but that provides a resistance when the unit tries to roll away from the user or off the stairs. This fixed amount of resistance against backwards movement may easily be overcome if the user needs to roll the unit in the opposite direction of normal travel, but is preferably of adequate force to ensure that the stairclimber presses up against the root of the stairs instead of rolling off the edge thereof.

A slip clutch resistance level(s) that is easy to intentionally overcome when needed is preferred, but not required, in the disclosed embodiments. Otherwise, it is preferred that the resistance level(s) provides adequate driving force for stairclimbing with heavy loads.

The advantages of this exemplary alternative clutch include, without limitation, the ability to provide a forward driving force and backwards locking force for a stair climbing device. Compared to devices with freely spinning wheels, the friction locking system increases ease of use and user safety by preventing the stair climbing device from easily rolling off the edge of the stairs or failing to properly advance to the next step without being pulled by the user. The slip clutch action prevents jamming and allows the stair climbing device to be rolled backwards if adequate force is intentionally applied by the user. This aspect of the invention is also significantly simpler, more reliable, and more cost effective to manufacture than prior art designs which use secondary motors, chain drives, gear drives, or other mechanisms to actively control the level of wheel locking resistance.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. A method of operation of a stair-climbing wheeled vehicle, said method comprising:
providing a wheeled vehicle comprising:
a rigid frame supporting a rotatable axle;
a pair of spider assemblies rotatably supported adjacent opposite ends of said axle, each of said pair of spider assemblies supporting a plurality of rotatable wheels coupled to rotate in synchronicity;
an angular position sensor supported on said frame in position to measure an angular position of one of said pair of spider assemblies relative to said frame; and
an electric motor supported on said frame and operatively connected to drive said pair of spider assemblies to rotate;
a power source supported on said frame an operatively connected to said electric motor;
a configurable slip friction clutch that provides resistance to rotation of the spider assemblies in one direction; and
a controller supported on said frame and operatively connected to said angular position sensor and said power source;
operating said angular position sensor to repeatedly measure an angular position of one of said pair of spider assemblies relative to said frame;
applying the resistance of the slip friction clutch to at least partially maintain rotation of the spider assemblies in a second direction; and
controlling said electric motor to cause application of varying rotational torque to said pair of spider assemblies to cause said pair of spider assemblies to maintain a selected angular position relative to said frame as a function Of measurements taken by said angular position sensor.
